(19) United States
(12) Patent Application Publication
(10) Pub. No.: US 2003/0120508 A1
(43) Pub. Date: Jun. 26, 2003

(54) Method and system for managing defined contribution accounts

(76) Inventors: Alan Kizor, Orinda, CA (US); Jacquelyn T. Silver, Fremont, CA (US)

Correspondence Address: JACKSON & CO., LLP, 6114 LA SALLE AVENUE, SUITE 507, OAKLAND, CA, 94611-2802, US

(21) Appl. No.: 10/322,105

(22) Filed: Dec. 17, 2002

Related U.S. Application Data
(60) Provisional application No. 60/341,828, filed on Dec. 21, 2001.

(51) Int. Cl. G06F 9/00; G06F 17/60

(52) U.S. Cl. 705/1

(57) ABSTRACT

Method and system for providing a web-based software platform which allows multiple financial institutions to administer retirement savings programs within and across multiple countries, contend with disparate national rules and regulations, offer plan sponsors the opportunity to monitor retirement benefit programs across national boundaries, and enable employees to enjoy self-service of their accounts worldwide is disclosed. More specifically, a shared infrastructure that provides combined participant recordkeeping and trust administration with custody at the participant level for retirement saving plans including Individual Retirement Account (IRA) Rollovers is disclosed. The web-based platform is configured to accommodate simple to complex plan provisions and be compliant with relevant rules and regulations, and further, to include a global multi-manager platform for subscribing financial institutions on an applications service provider basis.

### RELATED APPLICATION

This application claims priority under 35 USC §119 to provisional patent application No. 60/341,828 filed on Dec. 21, 2001 entitled “System and Method for Managing Defined Contribution Accounts” the disclosure of which is incorporated herein by reference for all purposes.

### BACKGROUND OF THE INVENTION

A profound change is taking place in the way Europeans and Asians save for retirement. Countries, reacting to the financial implications of longer life expectancies, are re-tooling their traditional public and private pension plans. Many nations are providing incentives to establish defined contribution (DC) plans, similar to the 401(k) plan already popular in the United States. Over the next 5-7 years, U.S. private retirement assets, now at $9 trillion, are expected to double. With an additional $6 trillion forecasted from Europe and Asia, a massive pool of approximately $24 trillion is building worldwide.

A DC plan is an employer-sponsored retirement plan that is based on the employee's and/or the employer's contributions to the plan over time, and the earnings thereon, rather than a monthly pension that is calculated from length of service and final average salary, as in a Defined Benefit (DB) plan. In the DB plan scenario, the employer (plan sponsor) bears the financial risk for funding the employees' monthly retirement income, for as long as the employee lives. In a DC plan, the retirement benefits are limited to the contributions and earnings buildup in the plan, and are usually paid to the employee in a lump sum at retirement, or used to purchase an annuity for the retiree.

The employer-sponsored savings channel enjoys the support of both companies and workers. Defined Contribution (DC) plans permit employers to shift much of the responsibility for retirement savings onto employees, yet still contribute materially into employee accounts. Workers appreciate the tax benefits, access and control of their employer-sponsored retirement plans. However, DC plans such as 401(k) plans in the United States, require a complex and costly administrative infrastructure.

In the United States alone, where the shift to DC plans has been underway for 20 years, more than 50 million individuals participate in their employer-sponsored 401(k) plans. A $12 billion a year industry emerged to provide services, investments, and infrastructure to support DC plans. This industry is expected to triple globally over the next 5-7 years. The maturing of the DC industry in the U.S. has shown that proprietary solutions create high market entry costs and high market leadership costs for growth.

Like their U.S. counterparts, European and Asian providers will likely need to develop computerized systems to administer DC plans. These systems may need to perform participant record keeping, plan sponsor administration, and trust accounting. Unlike their U.S. counterparts, however, these systems need to accommodate disparate regulations for each country. The costs of developing separate solutions for each country may be a significant impediment to many providers' ability to enter this otherwise lucrative market.

In response to increased life expectancy and its related cost of retirement, there is a global trend to shift more responsibility for accumulating retirement savings onto workers. Governments and companies, including US-based employers with employees located overseas as well as many foreign companies, are advocating DC-style programs. Workers appreciate the benefit of a tax-advantaged individual account, which seems more tangible and accessible than a future pension. At the same time, companies want to provide comparable retirement benefits across national boundaries.

As a result of the insufficiency to support the world's aging population, countries are not promoting retirement savings using every possible channel in recognition of the rising costs to support longer life expectancy. Governments alone cannot afford to carry the burden of financing pensions. Tax-advantaged programs are being introduced to encourage companies and individuals to play a greater role in the accumulation of retirement assets. It is expected that a new surge of assets will be available that will require management and administration, generating billions in revenue for financial institutions who effectively compete for retirement savings.

As DC plans become more popular in more countries, each country with unique and complicated rules surrounding the administration of these tax favored plans, financial institutions are challenged to develop an effective response to seize the opportunity, but also to avoid building costly and redundant administrative systems and infrastructure. The convergence of these trends creates opportunities and challenges for financial services providers:

Countries worldwide recognize the insufficiency of current pay-as-you-go programs to fund public pensions for aging populations and are responding with new tax-advantaged retirement vehicles, especially DC plans;

There is a vast new global surge in retirement assets. Already doubling over the last six years, the over $9 trillion asset pool in the US and its significant counterparts around the world, is expected to double in the next 60 months;

Investment managers want to expand globally to compete for the billions in asset management and administration fees;

Plan sponsors want, to the degree possible, consistent retirement plan provisions across national boundaries;

Employers globally are pushing responsibility for gathering retirement wealth to workers;

Employees appreciate the tax benefits, access and control of their employer-sponsored retirement plans;

Managing an employee's wealth beyond the working years is an opportunity created in a natural continuum of established relationships;

DC administration profitability requires a new infrastructure and a new economic model.

Since their introduction twenty years ago, DC plans, especially employer-sponsored 401 (k) plans, have moved from relative obscurity to center stage as an enormously popular retirement savings vehicle. The tax advantages for employees and plan sponsors have fueled the widespread acceptance and spawned an industry.

Based on one estimate, there are $12 billion in service and asset based annual revenues generated from 401 (k) plans alone. Moreover, the percentage of the work force covered by defined contribution plans has grown at an annualized rate of 7% per year since 1975, while defined benefit coverage has shrunk by 0.8% per year.

Many US financial institutions are looking beyond the management of assets for individuals during their working years and foresee an opportunity to capture the assets once they are distributed from the plan-in the form of IRA rollovers. There is an additional $1.7 trillion in IRA rollovers now, and the amount will nearly double to $3.2 trillion as baby boomers start retiring over the next five years.

Because of the immense size of the US market, a number of providers have created a variety of entry strategies, and many of those have since been modified in response to changing conditions. Over the course of two decades, several trends have emerged as providers tried to offer investment products and meet the service requirements. For example, it is possible to discern three distinct approaches as servicing the market has evolved.

In the first approach which focuses on unbundled DC management, DC plans require that multiple distinct functions be performed:

1. Participant Record keeper. Traditionally the function of “plan administration” was performed by employee benefits consulting firms. These firms would establish and maintain accounts for each employee, allocate fund earnings, and generate quarterly participant statements. Such firms also provided assistance with plan design, employee communications and compliance testing.

2. Plan Trustee. Banks were usually chosen for this function since many already had trust powers and dealt with cash and securities processing. Trustees reported on total plan assets which would be reconciled to participant accounts and handled plan distributions and routing of funds to investment managers.

3. Investment funds. Initially these were commingled trust funds offered by banks, asset managers or insurance companies. As time progressed, due to their daily valuation, brand recognition, and easy access to pricing in newspapers, mutual funds emerged as the dominant investment choice.

Coordinating the various companies required to support DC plan functions is cumbersome and expensive for plan sponsors. It often resulted in delays in making investment changes, producing reports and statements, and sometimes resulted in unexpected accounting distortions during periods of market volatility.

The second approach focuses on bundled record keeping, investments and trust service. Large financial institutions recognized that internally integrating their funds management, trustee services and record keeping systems allowed them to offer “bundled” DC services to their plan sponsor clients. With ‘one-stop’ shopping, leading institutions could create exit barriers by deepening their client relationships.

The weight of this additional service has delayed profitability for all providers, and prohibited profitability for some. The costs of this administrative infrastructure have been borne largely by the participants through their purchase of retail-priced mutual funds. The expense ratios of these funds were sufficiently large to help subsidize the costs of this enriched infrastructure.

The third approach which focuses on consolidation stemming from intense competition among the leaders which has resulted in fewer players, with a proliferation of acquisitions and mergers, particularly of unbundled and smaller providers. In order to win new business, surviving providers have been required to open their single-source investment choices to non-proprietary funds.

Competitive differentiation has also required expanding the borders of investment sources and changing the economics of DC management. The addition of self-directed brokerage ‘windows” and institutionally priced funds has eroded the margins for current providers. There is also a trend towards institutionally-priced funds to further reduce costs for participants.

With the increased pressure to offer a wider choice of less expensive funds, and the increasing demands of plan sponsors and participants to manage their wealth creation effectively, DC providers are under siege. DC providers are building large-scale DC administration operations centers to reduce costs. DC providers are also enhancing their technology infrastructure to keep pace with service competition. However, DC providers are becoming increasingly locked into their separate proprietary cost structures and solutions. The cost of remaining a viable player is borne over and over again by each leader. Since the profit margins on funds are shrinking, this silo effect may likely reach a point of reduced service quality across all providers. Research and development dollars for market expansion pose further constraints.

The historical lessons from the evolution of DC management in the United States seem fairly clear. They are:

The current economic model for DC administration is not effective enough against declining fund fees

Re-engineering the economic model by building large-scale DC administration operations centers has helped reduce costs by reducing redundancy and achieving some economies of scale—smaller silos have been contracted into larger silos; however, volume-scale economies have returned only marginal cost savings: the underlying business processes still reflect the original separation of duties found in DC administration-the services themselves have not been re-engineered

Record keeping and trust functions are separate subsystems among DC administration systems: customization for market leadership has resulted in tangles of interfaces between subsystems, a co-dependency that continuously increases cost; and

Plan by Plan administration dominates the DC administration world-the market has never moved from custom handling of plans into straight-through processing management, predominantly because the underlying technology in place has become too institutionalized and too complex to replace.

The outlook for the U.S. market is strong, although in a state of flux, as providers try to improve the economics of serving the business. Based on one study, emerging providers are teaming up with known distribution channels, using private label or co-branding to gain rapid market presence. Unfortunately, top market leaders are not making a profit on their DC administration. Emerging providers are also struggling because their newer internet-based models are currently too simplistic and do not support customization, significant conversion, or robust compliance testing of existing DC plans. For all providers, it seems that an effective economic model for DC administration currently remains elusive.

It appears that both traditional DC providers and newer providers currently lack the know-how, for creating robust, profitable DC administration solutions. DC administration has not yet moved into the enterprise information age. Plan-by-plan management and the separation of job duties continue to plague profitability among the full service providers, due to embedded, legacy costs and cultures. Newer players have not yet shown the know-how for managing complex, full-service plans.

There is a need for a single DC administrative solution that addresses multiple country rules and regulations, allows employers to offer a benefit program with consistent features across national boundaries, and enables employee self-sufficiency through web-based self-service. Such a solution may cost-effectively accommodate necessary functionality and customization across different markets, currencies, languages, and clientele. Thus, a need exists for a single solution that administers and manages retirement assets around the world.

### SUMMARY OF THE INVENTION

One aspect of the present invention is a web-based software platform that allows multiple financial institutions to administer retirement savings programs within and across multiple countries, contend with disparate national rules and regulations, offer employers the opportunity to monitor retirement benefit programs across national boundaries, and enable employees to enjoy self-service of their accounts worldwide.

In accordance with one embodiment, a shared infrastructure that provides participant recordkeeping and trust administration for retirement savings plans is disclosed. The platform is configured to accommodate simple to complex plan provisions and be compliant with relevant rules and regulations. It is able to support millions of participants working for millions of companies.

In a further aspect of the present invention, there is provided a global infrastructure platform that summarizes information for providers and employers within and across countries, with language and currency options, a web-based combined participant recordkeeping and trust administration platform driven by local tax rules and regulations in each country, integral employee benefit trust accounting and participant recordkeeping, with custody at the participant level, a straight-through processing optimization to reduce provider back-office operations and systems costs, an enterprise-wide workflow routing to promote operations specialization and reduce back-office costs, an enterprise-wide administration with Exceptions and Alerts management rather than plan-by-plan administration, an event calendaring and follow-up to optimize operations scheduling, a pending and tracking of problem transactions to permit comprehensive management of all financial directives, a web-based self-service to promote end-to-end participant and plan sponsor transacting, a web-based technology platform accommodating private took and feel, business rules, and customizations as components of the shared infrastructure, scalable across multi-market segments so that products and services may be flexibly offered by providers across company-sponsored plan sizes and complexities, private branding and built-in platform customizations for provider differentiation, which may allow providers to build customized features onto the platform, a “one-click” IRA rollovers and account conversions allowing providers to flexibly transition participants across retirement product offerings, an integration with subscribing financial institution (Network Member) legacy systems, such as trading, general ledger, voice response, and check distribution systems, and a new level of information and reporting to facilitate a global understanding of retirement activity at the division (national and international), company, and country level, and aggregated across companies worldwide.

Additionally, a further aspect of the present invention includes a multi-manager platform from which the subscribing financial institutions can include their investment offerings. This platform of enterprise DC applications and connectivity may be managed by a service provider working with facilities management providers around the world.

The technology architecture in one aspect of the present invention may be designed for universal access. Standard web browsers, such as Microsoft's Internet Explorer, and internet or intranet access may be used for using the system applications. Alternatively, access from a Personal Digital Assistant (PDA) and wireless applications protocol (WAP) devices may be supported. This “thin client” design principle allows the services to grow without impacting the service users, and to keep pace with internet access device expansion without redesigning its infrastructure or applications.

The shared DC administration solution also utilizes standard Web Services interface protocols, so that messaging integration with internal legacy systems and external vendors is inexpensive to establish and easy to alter. Extensible Markup Language (XML), Simple Object Access Protocol (SOAP), Web Services Description Language (WSDL), Universal Description, Discovery and Integration (UDDI), and other Web Services object-oriented design principles can be employed across the entire infrastructure. Extensible Markup Language (XML) allows messaging interfaces using XML protocol for generic cross-system communications, so that interfaces can be coded once and left predominantly unchanged as legacy and vendor systems evolve.

The present invention of a further embodiment utilizes ubiquitous design through the internal applications and data base architectures. Extensible Stylesheet Language (XSL) may be used to render web screens, so that customized looks and feels can be readily implemented and changed by relying on dynamic web page assembly. XML documents may then be dynamically imported from customers directly into web-viewable materials without incurring the additional time and costs of reformatting.

The system's n-tiered architecture may include dynamic component objects in the second tier (the applications server tier). A container services tool, such as Microsoft's NET or BEA's WebLogic, may be employed, so that only retirement-services-related components need to be developed from ‘scratch’ typical applications services can be provided by the container services tools. Universal Modeling Language (UML) can be used, along with code and documents generation tools such as Rational Rose, for rapid object-oriented, modular components.

The data tier may utilize both relational databases and files. Component objects can be designed to insulate the request for data from the specific format and location of the information, again allowing for flexibility and expansion without significant time or cost impediments.

The types of retirement savings programs that may be supported by the various embodiments of the present invention are identified below. They include several of the initial and additional retirement product families that can be offered, including defined Contribution plans such as qualified employer plans authorized under U.S. Internal Revenue Code sections 401(a), 401(k), 403(b), and 457, individual Retirement Plans such as Rollover IRAs and Contributory IRAs, non-Qualified Plans/Funded Unapproved Retirement Schemes (FURBS)/“Top Up” Schemes, and Defined Benefit Plans/Final Salary Schemes

Yet a further embodiment of the present invention is an infrastructure platform that allows providers to administer DC plans across multiple countries, contend with disparate national rules and regulations, offer employers the opportunity to create consistent benefit programs across national boundaries, and enable employees to enjoy self-service of their accounts worldwide.

Additionally, still a further aspect of the present invention discloses a shared DC administrative infrastructure that may be made available to financial institutions worldwide. These institutions may participate in the network at one of two levels: as Network Members (e.g., subscribing financial institutions) or as Asset Management Alliances. Subscribing institutions such as mutual funds, banks, insurance companies, and brokerage firms, can have both asset management capabilities and trust powers. The present invention in one embodiment includes a global multi-manager platform for Network Members and Asset Management Alliances on an applications service provider (ASP) basis.

The network effect of the shared DC administration infrastructure can manifest itself through a leveraging of financial institutions who are strong in their own markets: the financial institutions can be the customer-facing organizations. In turn, these organizations, through the infrastructure, can rely on other Network Members to administer plans consistently for plan sponsor clients who operate facilities outside their corporate-office market place. Additionally, yet still a further aspect of the present invention may offer a multi-manager platform so that Network Members and other Fund Alliances may choose to include their investment offerings as part of special investment menus constructed for plan sponsors. By extending the reach of Network Members through virtual relationships, Network Members may be able to grow their retirement assets through global physical expansion and through Network Member relationships around the world.

As such, the system of the present invention in one aspect enables partnership with key Network Members to guarantee that the common DC infrastructure developed can provide a cost-effective and compelling shared global solution with attractive private label appeal. The shared administrative system can create a new level of information and reporting to facilitate a global understanding of DC activity at the division level (national and international), company level, country level, and worldwide. By raising the level of data to a global scale, a powerful new paradigm is introduced to DC administration.

The system embodying the principles of the invention can provide market leading functionality for its Network Members so that the transformation from investment manager to full-service provider is economically attractive and strategically sound. The community that can use the system may include:

Network Members—Banks, brokerage firms, insurance companies and mutual funds around the world who can offer asset management, record keeping and trust services to DC plan sponsors in their regional markets;

Asset Management Alliances—Funds managers around the world who can offer additional fund choices on an omnibus basis, but choose not to offer record keeping or trust services;

DC Global Networks—A specialized and experienced Applications Service Provider (ASP) who can develop and service enterprise DC administrative systems and infrastructure for the use of its Network Members.

The present invention in a further aspect may include a real-time web-based participant record keeping and integral trust accounting platform, driven by local tax rules and regulations, in the specific language and currency of the Network Member and their clients. The system and associated services can assist its Network Members where appropriate in establishing new plan sales, conversions, operations, compliance, employee communications, participant services, payroll processing and investment compliance. In particular, the various embodiments of the present invention may include:

A global data exchange that summarizes worldwide information for employers, affiliates, and asset managers;

A real-time web-based participant record keeping platform, driven by local tax rules and regulations in each country;

Integral employee benefit trust accounting with custody at the participant level;

Integral automated reconciliation between participant record keeping and plan-level trust reporting;

Integral control for maintaining plan-wide data integrity top to bottom and bottom to top;

Integral omnibus handling of trades so that net buys and sells reconcile at the plan level and at the Network Member level in funds trading while reducing trade costs with funds managers;

Integral front-to-back DC administration process supporting self-service and economic efficiency;

Automated cross-plan administration with Exceptions and Alerts management rather than plan-by-plan administration;

Web Services straight-through transaction processing for DC administration; and

Standardized event messaging for both integral DC administration and straight-through web services enterprise communications processing with vendors and asset managers; and

“One-Click” IRA Rollovers.

These and other features and advantages of the present invention will be understood upon consideration of the following detailed description of the invention and the accompanying drawings.

### BRIEF DESCRIPTION OF THE DRAWINGS

FIG. 1 illustrates an overall infrastructure for Defined Contribution Plans in accordance with one embodiment of the present invention;

FIG. 2 illustrates the Defined Contribution scope of product services in accordance one embodiment of the present invention;

FIG. 3 illustrates the architecture for implementing the infrastructure for Defined Contribution Plans of FIG. 1 in accordance with one embodiment of the present invention; and

FIG. 4 illustrates secure transaction network for the architecture for implementing the infrastructure for Defined Contribution Plans of FIG. 3 in accordance with one embodiment of the present invention.

### DETAILED DESCRIPTION OF THE INVENTION

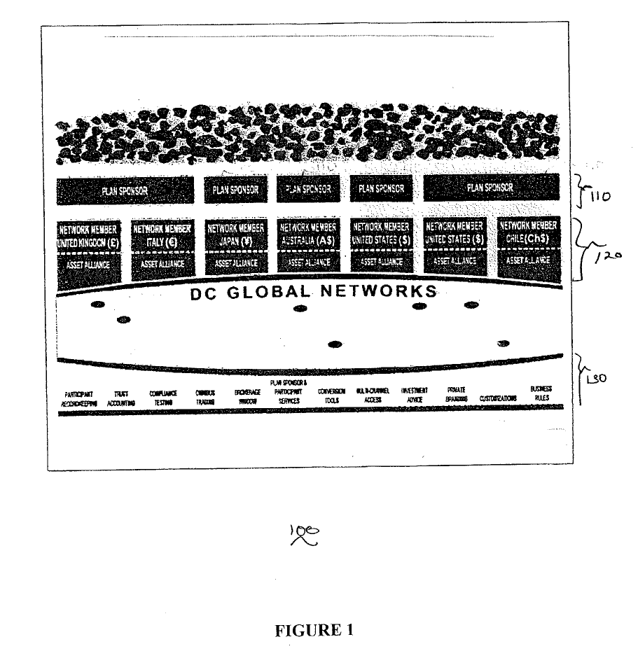

FIG. 1 illustrates an overall infrastructure for Defined Contribution Plans in accordance with one embodiment of the present invention. As can be seen, the overall system 100 includes a plurality of plan sponsors 110 as well as network members 120 and the corresponding asset alliance. The network members 120 may be assembled around the world and represent financial institutions with asset management expertise and trust powers, along with strong local presence and marketing skill in their country and region. The individuals who interact most effectively with the plan sponsors 110 and their participants may be the local network members due to knowledge of culture, language and environment.

In one aspect, the system can leverage advanced technology to build and enhance its engine to enable its network members 120 to compete efficiently and confidently. The system 100, through its members 120 and asset alliances, can provide access to quality funds across major asset classes with consistent historical investment performance and competitive fees. Further, the system 100 may also provide plan sponsors 110 and participants with easy, prompt, and reliable access to their accounts through online systems and interfaces to voice response systems and call centers supported by network members 120.

Referring back to FIG. 1, also shown in the overall infrastructure system 100 includes a plurality of available services 130. The services 130 include, in one aspect, participant recordkeeping, trust accounting, compliance testing, investment advice, and private banking, to name a few. In this manner, the DC administration is provided in shared service engines that are integrally designed to optimize business operations workflow and to introduce straight-through enterprise processing efficiency behind the scenes. Additionally, customization and differentiation that can enhance investment performance and service features may be included, and not waste market leader time and money on reinventing the mechanics of DC administration (the engine).

The pricing schedule for Network Members 120 is designed to accomplish the following objectives: (1) help recoup start-up costs and profitably cover associated fixed and variable costs, (2) be price leaders compared with other ASP/software providers, (3) be sufficiently affordable so as to discourage members from bringing processing in-house, and (4) Provide incentives for Network Members to rapidly grow their DC business.

The Network Member can expect to pay a one-time New Member charge (one country), per each additional country, per participant, for user access or “seats”, for plan sponsor access or “seats”, set-up charge for new plan sponsors, and for consulting, conversion, and training.

Asset management alliances, including brokerage alliances, may agree to pay asset-based fees or transaction fees to network members 120 for the distribution of their funds. Typically the range of such revenue sharing is between 25 and 45 basis points.

However, for alliance funds to participate in the Network (system 100), the following additional schedule may be required—Alliance Fund Family Set-up Charge, and annual fee per fund per country.

For the network members 120, member agility is provided through the communication, collaboration, and connection of Web Services technology components throughout the retirement products' enterprise value chain. The member 120 operations can further be optimized through automated straight-through transaction processing and integral record keeping/trust reconciliation. Additionally, entry into new markets is made relatively easy, and full service feature choices for competitive effectiveness is made available. Further, network members 120 may benefit from private branding (Look and Feel), business rules, and customizations to support market presence/strategy, synergistic market growth through Network Member relationships, and cost reduction.

Indeed, the infrastructure for expanding DCs worldwide is designed for full-service DC administration. Its product offerings are rich in depth for each client's needs. Investment choices and contribution (tax category) types are virtually unlimited. Business rules and traditional ‘customizations’ are virtually unlimited. Branding and appearance (‘skin’) choices are virtually unlimited. Share and unitized accounting options are available to support a variety of investment choices. A sample profile is offered below to show the range of services designed for each member of the network community.

I. Participants:

Online enrollment, including beneficiaries and profile information

Online funds selections and investment instructions

Online payroll deductions authorizations, where appropriate

Online credit card and debit account authorizations

Online investment advice and research

Online fund performance

Online Individual Weighted Average Investment Return

Online fund collateral materials

Online balance information

Online withdrawal and distributions requests, where appropriate

Online loan modeling and loan requests

Online transfers between investment funds

Online rebalancing of accounts

Online limit checking and plan compliance with each transaction

Online statements

Online updates on market trends

Online reminders and alerts

Online history of participant's wealth accumulation

Online transaction history

Online projection of current year contributions

Online linkages for self-directed brokerage, where offered

Online ad hoc reporting/graphs

Context-sensitive Help

Online Help (Chat, Collaboration), where offered

II. Plan Sponsors:

Online Plan design guides

Online Plan set-up/maintenance

Online Plan documents

Online fund choices

Online fund performance

Online fund collateral materials

Online investment advice and research

Online Plan Eligibility analysis

Online Plan participation analysis

Online Plan balances

Online Plan loans analysis

Online Plan forfeitures analysis

Online withdrawals history

Online disbursements history

Online payroll contributions analysis

Online other contributions (credit card, ATM) analysis

Online payroll processing reviews

Online Plan statements

Online Plan history

Online Company Match programs and analysis

Online Compliance analysis

Online Trust reporting

Online Plan fees management

Online ad hoc and standard reporting/graphs

Online Plan Sponsor set-up/maintenance

Online workflow routing for approvals of participant requests (loans, withdrawals, disbursements, QDROs), where appropriate

Online projection of current year contributions

Multi-national consolidations and drill downs for above functions

Online linkages to company intranet/internet

Context-sensitive Help

Online Help (Chat, Collaboration), where offered

Virtually unlimited investment options

Virtually unlimited contribution (tax category) types

Virtually unlimited business rules and ‘customizations’

Virtually unlimited branding options

Share or unitized accounting options for employer stock

Unitized accounting for mutual funds

III. Network Members (DC Administrators):

Online Participant and Plan Sponsor Services:

I. Participants:

Online enrollment, including beneficiaries and profile information

Online funds selections and investment instructions

Online payroll deductions authorizations, where appropriate

Online credit card and debit account authorizations

Online investment advice and research

Online fund performance

Online Individual Weighted Average Investment Return

Online fund collateral materials

Online balance information

Online withdrawal and distributions requests, where appropriate

Online loan modeling and loan requests

Online transfers between investment funds

Online rebalancing of accounts

Online limit checking and plan compliance with each transaction

Online statements

Online special requests (QDROs)

Online updates on market trends

Online reminders and alerts

Online history of participant's wealth accumulation

Online transaction history

Online projection of current year contributions

Online linkages for self-directed brokerage, where offered

Online ad hoc reporting/graphs

Context-sensitive Help

Online Help (Chat, Collaboration), where offered

II. Plan Sponsors:

Online Plan design guides

Online Plan set-up/maintenance

Online Plan documents

Online fund choices

Online fund performance

Online fund collateral materials

Online investment advice and research

Online Plan Eligibility analysis

Online Plan participation analysis

Online Plan balances

Online Plan loans analysis

Online Plan forfeitures analysis

Online withdrawals history

Online disbursements history

Online payroll contributions analysis

Online other contributions (credit card, ATM) analysis

Online payroll processing reviews

Online Plan statements

Online Plan history

Online Company Match programs and analysis

Online Compliance analysis

Online Trust reporting

Online Plan fees management

Online ad hoc and standard reporting/graphs

Online Plan Sponsor set-up/maintenance

Online workflow routing for approvals of participant requests (loans, withdrawals, disbursements, QDROs), where appropriate

Online projection of current year contributions

Multi-national consolidations and drill downs for above functions

Online linkages to company intranet/internet

Context-sensitive Help

Online Help (Chat, Collaboration), where offered

Virtually unlimited investment options

Virtually unlimited contribution (tax category) types

Virtually unlimited business rules and ‘customizations’

Virtually unlimited branding options

Interface formats for links to Voice Response (VRU) and Computer Telephone (CTI) systems

Online participant and Plan record keeping

Online Trust reporting

Online payroll processing

Online payroll wire transfers reconciliation

Online Control accounting and reconciliation

Online omnibus trading analysis, tracking and reconciliation

Interfaces templates to trading system(s)

Online trading adjustments and reconciliation

Online checks or interfaces to check systems for loans, withdrawals, and disbursements

Online check adjustments and reconciliation

Online proxy lists

Annual paper statements, where required

Tax reporting analysis (5500s, distributions, etc.)

Online Plan Sponsor relationship management

Online Consolidated Network Member reporting (DC assets, DC administration trends)

Online DC administration fees assessment, billing and reconciliation

Online Compliance monitoring/testing

Online regulatory history and audit reporting (SAS70)

Omnibus accounting and reporting

Daily reconciliation between Plan Sponsors and Network Member

Shareholder Servicing and Transfer Agency for distribution of dividends and other capital changes

NAV interfaces for fund prices

NAV adjustments

Prior-period participant and plan adjustments

‘Blue Sky’ reporting interfaces

IV. Asset Managers:

Inclusion in Plan Sponsor fund choices

Online fund collateral materials (prospectuses, etc.)

Online fund performance and history distribution to plan sponsors and participants

Shareholder Servicing and Transfer Agency for distribution of dividends and other capital charges

NAV interfaces for fund prices

NAV adjustments

Interfaces to Network Members for trading and adjustments

Tracking, accounting, and reconciliation of trades from Network Members

As discussed in further detail below, the present invention in one embodiment may include a technology platform that combines record keeping and trust reporting, and moves beyond plan-by-plan administration into enterprise management, thereby realizing a new paradigm of automated straight-through processing inside DC administration operations and service centers. Web-based reach with its continuous demand for brand recognition, customization and freshness, makes mass customization possible. Outside DC administration operations and service centers, standardized event messaging using internet protocols creates an integrated straight-through transactional network, where a global community of companies, employees, payroll providers, DC administrators, and asset managers can participate in a continuous “best of breed” array of choices while driving up their wealth and profitability.

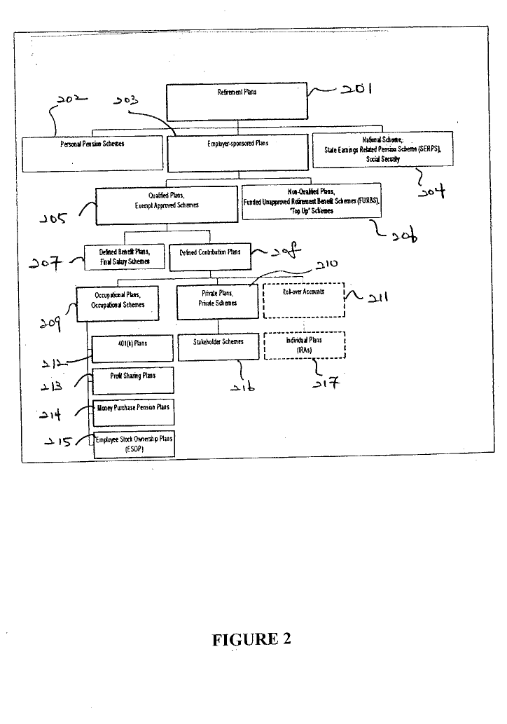

FIG. 2 illustrates the Defined Contribution scope of product services in accordance one embodiment of the present invention. As shown, retirement plans 201 may include personal pension schemes 202, employer-sponsored plans 203 and national scheme 204 such as state earning related pension scheme (SERPS) and social security. The employer-sponsored plans 203 may additionally include qualified plans and exempt approved schemes 205, as well as non-qualified plans, funded unapproved retirement benefit schemes (FURBS), and “Top Up” schemes 206. Additionally, the qualified plans and exempt approved schemes 205 may include defined benefit plans and final salary schemes 207, as well as defined contribution plans 208.

Within the defined contribution plans 208 includes occupational plans and schemes 209, private plans and private schemes 210, and roll-over accounts 211. The occupational plans and schemes 209 may further include 401(k) plans 212, profit sharing plans 213, money purchase pension plans 214, and employee stock ownership plans (ESOP) 215. Moreover, several of the additional retirement product families that may be offered include public plans (DC plans for Governments, municipalities, etc.) (not shown), and not for profit plans (DC plans for “Not For Profit entities) (not shown).

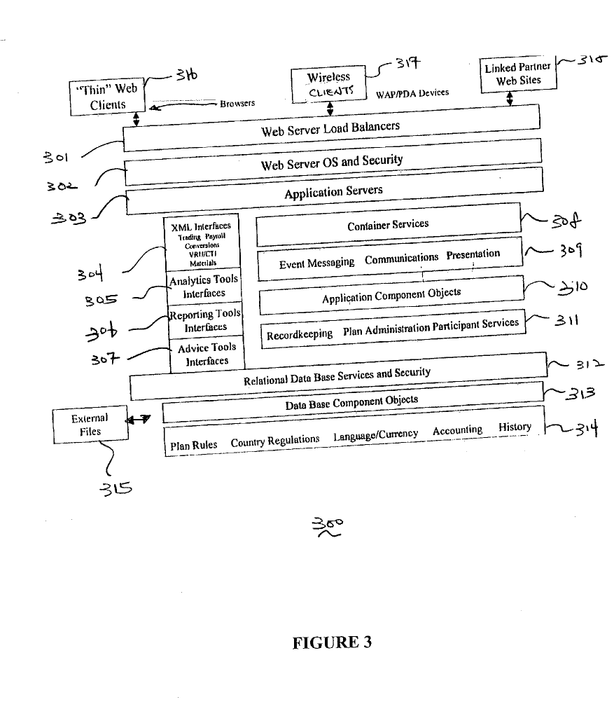

FIG. 3 illustrates the architecture for implementing the infrastructure for Defined Contribution Plans of FIG. 1 in accordance with one embodiment of the present invention. As shown, the overall architecture 300 includes web server load balancer layer 301 which interacts with one or more of “thin” web clients 316 via browsers, wireless clients 317 via WAP/PDA devices, and linked partner web sites 318. Also provided in the overall architecture 300 is web server OS and security layer 302, and applications server layer 303. Referring to FIG. 3, also shown are XML interfaces 304, as well as a plurality of interfaces such as analytics tools interfaces 305, reporting tools interfaces 306, and advice tools interfaces 307. Also can be seen from the Figure are container services layer 308, event messaging, communication and presentation layer 309, application component objects layer 310, and recordkeeping, plan administration and participant services layer 311.

For data storage and information retrieval, relational data base services and security layer 312 is provided. Also shown in FIG. 3 is data base component objects layer 313 as well as external file interfaces 315 from which and to which information may be stored and/retrieved. Additionally, it can be seen from the Figure that plan rules, country regulations, language/currency information, accounting as well as history (layer 314) is provided in the overall architecture 300.

Indeed, the overall system 100 (FIG. 1) includes a Web Services technology architecture 300, enabling online access anywhere, anytime for participants, plan sponsors, network members, and funds managers. The system 100 (FIG. 1) includes a worldwide integrated infrastructure of distributed servers to ensure rapid online response time and continuous availability. This platform of enterprise DC applications and connectivity will be managed by a service provider working with facilities management providers around the world.

Referring back to FIG. 3, in one embodiment, the technology architecture is designed for universal access. Standard web browsers, such as Microsoft's Internet Explorer, and internet or intranet access are used for using the system applications. Alternatively, access from a Personal Digital Assistant (PDA) and wireless applications protocol (WAP) devices may be supported. This “thin client” design principle allows the services to grow without impacting the service users, and to keep pace with internet access device expansion without redesigning its infrastructure or applications.

According to one embodiment of the invention, the shared DC administration solution also utilizes standard Web Services interface protocols, so that messaging integration with internal legacy systems and external vendors is inexpensive to establish and easy to alter. Extensible Markup Language (XML), Simple Object Access Protocol (SOAP), Web Services Description Language (WSDL), Universal Description, Discovery and Integration (UDDI), and other Web Services object-oriented design principles can be employed across the entire infrastructure. Extensible Markup Language (XML) allows messaging interfaces using XML protocol for generic cross-system communications, so that interfaces can be coded once and left predominantly unchanged as legacy and vendor systems evolve.

In this manner, DC providers worldwide may be provided with the opportunity to improve their scalability across small and large markets, their reliability and control, their product flexibility, and their ability to grow their market places, all while significantly improving the economics of their business. By building a technology platform that combines record keeping and trust reporting, and moves beyond plan-by-plan administration into enterprise management, a new paradigm of automated straight-through processing inside DC administration operations and service centers may be realized. Web-based reach with its continuous demand for brand recognition, customization and freshness, allows mass customization possible. Outside DC administration operations and service centers, standardized event messaging using internet protocols creates an integrated straight-through transactional network, where a global community of companies, employees, payroll providers, DC administrators, and asset managers can participate in a continuous “best of breed” array of choices while driving up their wealth and profitability.

Additionally, the present invention in a further aspect may use ubiquitous design through the internal applications and data base architectures. Extensible Stylesheet Language (XSL) can be used to render web screens, so that customized looks and feels can be readily implemented and changed by relying on dynamic web page assembly. XML documents may then be dynamically imported from customers directly into web-viewable materials without incurring the additional time and costs of reformatting.

Referring back to FIG. 3, the system's three-tiered architecture may include dynamic component objects in the second tier (the applications server tier 303). A container services tool, such as BEA's WebLogic, may be employed, so that only DC-related components need to be developed from ‘scratch’ typical applications services can be provided by the container services tools. Moreover, universal Modeling Language (UML) can be used, along with code and documents generation tools such as Rational Rose, for rapid object-oriented, modular components.

The data tier may utilize both relational data bases and files. Component objects can be designed to insulate the request for data from the specific format and location of the information, again allowing for flexibility and expansion without significant time or cost impediments.

Additionally, ubiquitous computing principles can not only ensure longevity in computing evolutions, but can also minimize the time and cost of customization and change. Moreover, device compatibility, such as PCs, PDAs, and wireless, can be adapted and managed by standard browsers. Also, screens may be dynamically designed, so that customers can almost fashion and refashion their own look and fees without technical support. Environment management may be achieved through tools, not through custom code, and functions specific to DC administration can be object-oriented in order to keep code to a minimum and to keep it pertinent. Code generation and documentation tools may be used wherever possible for these custom objects. Data can be insulated from the application, not just for security reasons, but also to allow for ease of change as new enhancements occur. Interfaces between systems and applications can be message-based for loosely-coupled integration, so that internal changes can be made with minimal impact on other systems. Also, Ad Hoc Reporting tools can be used, since even ‘canned’ reports require repeated change. Ad Hoc templates can be provided to dynamically generate ‘canned’ or frequently requested reports. Messaging design can be used to synchronize data around the world. Real-time online DC administration can be used to provide timely and flexible services—batch processing can be avoided wherever possible, thereby ensuring balanced, accurate DC administration anywhere, anytime.

Integral or tightly coupled design is container design. All functions interoperate in one cohesive process. Interfaceable or coupled design is stand-alone function design. All functions operate independently. While a coupled design can be used for bringing to business steps that occur separately, such as trading or general ledger accounting, a single system design can be used for business steps that should occur concurrently, such as record keeping and trust reporting.

According to one embodiment, add-on customization allows customers to ‘plug’ unique or differentiating components onto the core system engine, in effect, changing the engine by extensions. Turbo-charged customization demands that the core system engine reach out front to back in the enterprise business process. Customization for uniqueness or differentiation is accomplished through integral user rules, UL, and other aspects of the core engine. Changing the skin is an internet term for the popular demand to brand the look and feel and messaging of a core engine component.

Changing the rules is a term for the popular demand to brand how the engine runs. History has shown that add-on customization tends to become uncontrolled (creates workflow and balancing nightmares for customers), costly (requires creation and recreation), and generally unsophisticated (requires continuous current market intelligence of each customer). Conversely, changing the skin has proven an inexpensive customization strategy for continuously raising the bar while accommodating taste and uniqueness. While both provide differentiation, add-on customization appears less effective.

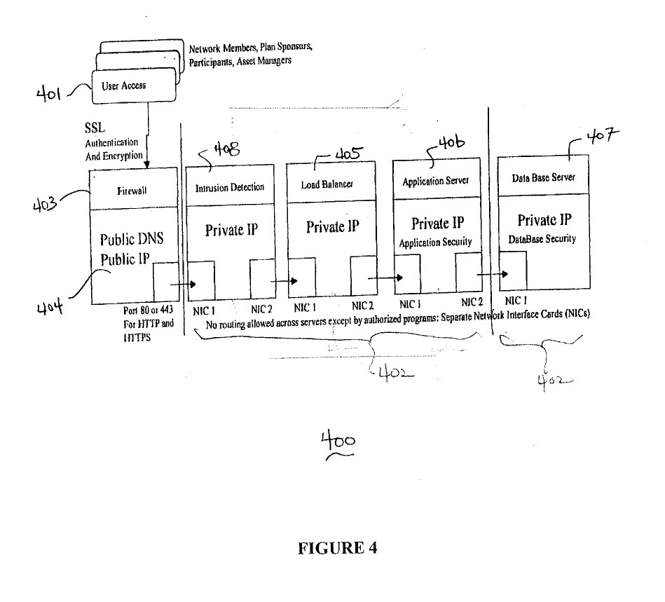

FIG. 4 illustrates secure transaction network for the architecture for implementing the infrastructure for Defined Contribution Plans of FIG. 3 in accordance with one embodiment of the present invention. The secure transaction network 400 shown in FIG. 4 in one embodiment is configured to ensure that all web activity are secured. Indeed, transactions traveling over the internet or the intranet as between user access terminals 401 and one or more of the separated private network segments 402 may be encrypted using Secure Sockets Layer (SSL) protocol. SSL employs RSA public/private key cryptography and X.509 Certification Authorities for authentication and message encryption. SSL is available with web browsers. SSL is a security option for automated authentication and cryptography; however, as newer certification systems emerge, alternative certification systems may be used, as browsers shift their standards.

Hacking prevention inside the system's web sites can utilize the known prevention techniques in networking. Public internet protocol addresses (IPs) 404 can be available only for the firewalls 403 protecting each site. Behind the firewalls 403, intrusion detection 408, load balancers 405 and applications servers 406 can be screened from external detection through the use of private IP addressing. Further behind the firewalls 403, database servers 407 can be separated by another set of private IP addresses and network interface cards (NICs), so that only authenticated applications-generated transactions can be permitted access to the private network segments containing the data servers. To further avoid potential ‘cross-contamination,’ all network members and plan sponsors can have their data isolated from each other. By using separate tables and files, permissions for authenticated applications-generated transactions can thereby be restricted to each client.

The system's web sites can also be continuously monitored for unusual activity through the use of Intrusion Detection Software. Defensive responses in the event of unusual activity attacks can be automatically invoked. Fallover processing and alternate routing at the Domain Name System (DNS) level can also be employed when/if ‘denial of service’ attacks occur. Moreover, the system may deploy known techniques for the prevention and detection of internet fraud. As further advances are made in automation tools for authentication of clients, the system will continuously update its protection services. The system can utilize the findings of such organizations as the Information and Communications Technologies Standards Board (ICTSB) and the European Electronic Signature Standardization Initiative (EESSI) to insure compliance and conformity with security standards.

As can be seen, security may be designed to discourage and avoid cyberterrorism, a term referring to security violations on internet sites. First, careful protection can be afforded for ‘legitimate’ business. Participant, Plan Sponsor, Network Member, and Asset Manager privileges can be assigned by authorized agents inside each company. Passwords can then be chosen and known only to the individual. Personal information ‘tokens’ can also be used as appropriate for certain requests, in order to validate logon privacy. For example, requests for funds withdrawals, loans, and disbursements, all of which involve money leaving a participant's account, can be accorded corroborative authentication by means of tokens and by automated workflow routing to DC Plan Sponsors for internal company review. By way of another example, automated preprocessing authorization cycles can be used for direct contributions from credit cards and debit/ATM accounts when these forms of contribution are supported by national regulations and the Plan Sponsors. This continuous form of ‘Double custody’ control over funds distributions and other sensitive authorizations can be elected by each client's company policies: the infrastructure can support these multiple options for continuous protection of participant funds.

The various processes described above including the processes operating in the software application execution environment in the overall system 100, architecture 300, and the secure transaction network 400, performing the processes and routines described in conjunction with FIGS. 1-4 above, may be embodied as computer programs developed using an object oriented language that allows the modeling of complex systems with modular objects to create abstractions that are representative of real world, physical objects and their interrelationships. The software required to carry out the inventive process, which may be stored in a memory of the architecture 300 (FIG. 3), may be developed by a person of ordinary skill in the art and may include one or more computer program products.

In the manner described above, in accordance with the various embodiments of the present invention, there is provided a web-based software platform that allows multiple financial institutions to administer retirement savings programs within and across multiple countries, contend with disparate national rules and regulations, offer employers the opportunity to monitor retirement benefit programs across national boundaries, and enable employees to enjoy self-service of their accounts worldwide.

More specifically, there is provided a shared infrastructure that provides combined participant recordkeeping and trust administration with custody at the participant level and rollover IRAs for retirement savings plans is disclosed. The platform is configured to accommodate simple to complex plan provisions and be compliant with relevant rules and regulations. It is able to support millions of participants working for millions of companies.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A system for providing a shared data communication infrastructure, comprising:
a data network;
one or more network members configured to operatively communicate via the data network; and
a service provider configured to operatively communicate with said one or more network members via said data network;
a plan sponsor configured to operatively communicate with said one or more network members and the service provider; and
a participant configured to operatively communicate via said data network with the one or more network members, the service provider, and the plan sponsor.

2. The system of claim 1 wherein said data network includes a secure data network.

3. The system of claim 1 wherein said participant is operatively coupled to said data network via an internet connection.

4. The system of claim 1 wherein information for communication via said data network among said participant and said one or more network members, the service provider, and the plan sponsor includes financial data.

5. The system of claim 1 wherein the service provider is configured to provide one or more of a brokerage service, an investment advice service, a payroll service, an investment service, and an investment information service.

6. The system of claim 1 wherein said service provider is configured to provide a combined recordkeeping service and trust administration for retirement saving plans with custody of plan assets held at an account corresponding to the participant.

7. The system of claim 1 wherein the one or more network members, the service provider, the plan sponsor, and the participant are configured to communicate via said data network within and/or across multiple countries.

8. A method of administering a financial program, the method comprising the steps of:
receiving a financial account information from a participant, said financial account information including a profile of said participant;
retrieving one or more financial programs corresponding to said participant profile; and
transmitting information corresponding to said retrieved one or more financial programs to said participant.

9. The method of claim 6 wherein said transmitted information includes one or more of an account balance information, an available account option information, and an account transaction information.

10. The method of claim 6 wherein said received financial account information is encrypted.

11. The method of claim 6 wherein said retrieved one or more financial programs includes a retirement savings program.

12. A program storage device readable by a machine, tangibly embodying a program of instructions executable by the machine to perform a method of administering a financial program, the method comprising the steps of:
receiving a financial account information from a participant, said financial account information including a profile of said participant;
retrieving one or more financial programs corresponding to said participant profile; and
transmitting information corresponding to said retrieved one or more financial programs to said participant.
